(19) United States
(12) Patent Application Publication
(10) Pub. No.: US 2015/0295255 A1
(43) Pub. Date: Oct. 15, 2015

(54) PURGE CONTROL SYSTEM AND METHOD FOR FUEL CELL

(71) Applicant: Hyundai Motor Company, Seoul (KR)

(72) Inventor: Ho June Bae, Hwaseong (KR)

(21) Appl. No.: 14/542,619

(22) Filed: Nov. 16, 2014

(30) Foreign Application Priority Data
Apr. 14, 2014 (KR) 10-2014-0043936

(51) Int. Cl. H01M 8/04

(52) U.S. Cl. CPC H01M 8/04104

(57) ABSTRACT

A purge control system and method is provided. In particular, one or more sensors measure pressures of an anode and a cathode of a fuel cell stack. A controller, then controls the pressures of the anode and the cathode so that a pressure difference between the anode and the cathode is maintained at a predetermined reference differential pressure. The controller also determines an opening time and an opening cycle according to an output of a fuel cell stack necessary for a vehicle, and opens and closes a hydrogen purge valve according to the determined opening time and opening cycle.

### CROSS-REFERENCE TO RELATED APPLICATION

This application claims under 35 U.S.C. §119(a) the benefit of Korean Patent Application No. 10-2014-0043936 filed on Apr. 14, 2014, the entire contents of which are incorporated herein by reference.

### BACKGROUND

(a) Technical Field

The present invention relates to a purge control system and method for a fuel cell. More particularly, it relates to a purge control method for a fuel cell, which can improve the stability against fire and explosion by maintaining the concentration of discharged hydrogen at a desired level and accurately control an anode at a desired concentration by allowing hydrogen to be discharged at a constant rate through a hydrogen purge valve when the hydrogen purge valve is opened.

(b) Background Art

A fuel cell system applied to a hydrogen fuel cell vehicle, which is one of eco-friendly future vehicles, includes a fuel cell stack generating electrical energy from an electrochemical reaction of reaction gases (e.g., hydrogen as a fuel and oxygen as an oxidant), a hydrogen supply unit for supplying hydrogen, e.g., to supply fuel to the fuel cell stack, an air supply unit for supplying air including oxygen to the fuel cell stack, a heat and water management system that is configured to control the operation temperature by emitting heat from the fuel cell stack to the outside and performing a water management function, and a fuel cell system controller configured to control the overall operation of the fuel cell system through the use of processor and memory specifically programmed to control the operation of the fuel cell system.

FIG. 1 is a view illustrating a typical fuel cell system. A hydrogen supply unit like the one shown in FIG. 1, typically includes a hydrogen storage (hydrogen tank) 21, high/low pressure regulators (not shown), a hydrogen supply valve 23, and a hydrogen recirculation line 24. An air supply unit generally includes an air blower 31 and a humidifier 32. Also, a heat and water management system (not shown) typically includes an electric water pump (coolant pump), a water tank, and a radiator.

High-pressure hydrogen supplied from the hydrogen tank 21 of the hydrogen supply unit sequentially passes through high/low pressure regulators, and then is supplied to the fuel cell stack at a low pressure. The hydrogen recirculation line 24 enables the reuse of hydrogen by recirculating unreacted hydrogen remaining after the reaction in the anode of the fuel cell stack 10 using an ejector 25 and/or a recirculation blower (not shown).

Along with the operation of the fuel cell stack 10 of the fuel cell system, nitrogen from the air supplied to the cathode of the stack and moisture (e.g., water and/or vapor) generated in the cathode cross over to the anode through an electrolyte membrane inside the stack.

In this case, nitrogen lowers the partial pressure of hydrogen, reducing the performance of the stack, and generated water blocks the flow field, interrupting the movement of hydrogen. Accordingly, a periodic purge is needed to secure the stable performance of the stack and prevent the stack from becoming flooded.

As foreign substances such as nitrogen, water, and vapor crossing over to the anode through the electrolyte membrane inside the stack of the fuel cell increases, the amount of hydrogen inside the anode decreases, reducing the reaction efficiency. Accordingly, the hydrogen purge valve 40 needs to be periodically opened to purge foreign substances to the away from the cathode.

In particular, the hydrogen purge valve 40 for the hydrogen purge is typically provided in a line on an outlet side of the anode of the fuel cell stack 10 to periodically discharge hydrogen from the anode. Thus, foreign substances such as moisture and nitrogen from a bipolar plate of the fuel cell stack can be together discharged and removed, thereby increasing the utilization rate of hydrogen. When foreign substances are discharged out of the fuel cell stack, the concentration of the hydrogen increases, and the gas diffusion and reactivity are improved.

The hydrogen purge valve 40 may be an electronic control valve that periodically opens and closes according to a command from the fuel cell system controller (not shown) in order to manage the concentration of hydrogen. When the hydrogen purge valve 40 is opened, foreign substances such as moisture and nitrogen inside the fuel cell stack 10 can be discharged to the atmosphere through a vehicle exhaust port 34.

When the hydrogen purge valve 40 is opened during the operation of a vehicle, hydrogen can be discharged to the atmosphere through a back side of the cathode, an air exhaust line 33, and the exhaust port 34 subsequently with the foreign substances due to a pressure difference between the anode (relatively high pressure) and the cathode (relatively low pressure) of the fuel cell stack 10. Thus, the output of the fuel cell stack 10 can be maintained.

When the hydrogen purge is performed toward the back side of the cathode (i.e., the side opposite the anode) and the air exhaust line 33 due to opening the hydrogen purge valve 40, hydrogen discharged out of the anode is diluted with the exhaust gas of the cathode which is mainly made up of air to be discharged out of a vehicle. For this, a pressure difference needs to exist between the cathode and the anode.

As such, upon hydrogen purge, due to the pressure difference between the anode and the cathode, hydrogen is discharged from the anode to the back side of the cathode, and simultaneously, foreign substances of the anode can be together discharged. FIG. 2 is a graph illustrating a pressure difference maintained at a constant level between the anode and the cathode in a related art.

As shown in FIG. 2, the pressure of the anode is maintained at a certain level higher than that of the cathode such that hydrogen and foreign substances can be naturally discharged due to a differential pressure between the anode and the cathode when the hydrogen purge valve is opened.

In most examples, the hydrogen purge valve is opened for a certain time according to an output (hereinafter, referred to as a vehicle output) of the fuel cell stack necessary for a vehicle. A pressure profile is prepared in relation to the vehicle output through a predetermined experimentation, and is equally applied to all vehicles.

However, in the above examples, it is impossible to consistently maintain the hydrogen concentration of the vehicle exhaust port at a demand level (legal requirements: average hydrogen concentration for three seconds—less than about 4%, a maximum of about 8%). Particularly, when the amount of hydrogen is discharged together with foreign substances during the hydrogen purge, the hydrogen concentration at the exhaust port increases. This causes a risk of fire or explosion.

One means of addressing this problem is to delay exhaust by applying a chamber at a rear end of a hydrogen purge valve to control the concentration. However, since this method is effective only when a sufficiently large chamber is applied, it is difficult to apply this method to vehicles which have limited space.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a purge control system and method for a fuel cell, which can improve the stability of the fuel cell system against fire and explosion by maintaining the concentration of discharged hydrogen at a desired level while at the same time accurately controlling the anode at a desired concentration by allowing hydrogen to be discharged at a constant rate through a hydrogen purge valve when the hydrogen purge valve is opened.

In one aspect, the present invention provides a purge control method for a fuel cell, including: measuring, by a sensor, pressures of an anode and a cathode and controlling, by a controller based on pressure difference measured by the sensor, the pressures of the anode and the cathode such that a pressure difference between the anode and the cathode is maintained at a predetermined reference differential pressure. An opening time and an opening cycle are controlled by the controller according to an output of a fuel cell stack necessary for a vehicle and the control a hydrogen purge valve such that the hydrogen purge valve is opened according to the determined opening time and opening cycle.

In an exemplary embodiment, when the pressure difference between the anode and the cathode is less than the reference differential pressure, the pressure of the anode may be increased, and when the pressure difference between the anode and the cathode is greater than the reference differential pressure, the pressure of the cathode may be increased.

In another exemplary embodiment, when the pressure difference between the anode and the cathode is less than the reference differential pressure, the pressure of the anode may be increased by a value of “cathode pressure−anode pressure+reference differential pressure”, and when the pressure difference between the anode and the cathode is larger than the reference differential pressure, the pressure of the cathode may be increased by a value of “anode pressure−cathode pressure−reference differential pressure”.

In still another exemplary embodiment, as the output of the fuel cell stack necessary for the vehicle becomes less, the opening time and the opening cycle of the hydrogen purge valve may be shortened.

In yet another exemplary embodiment, the opening time and the opening cycle of the hydrogen purge valve may be determined by Equations (1) and (2) below:

tₒₙ (sec)=Vehicle Output(A)×Constant 1 (1)

t_{off} (sec)=Vehicle Output(A)×Constant 2 (2)

Here, the constants 1 and 2 are predetermined values and tₒₙ (sec) is time on and t_{off} (sec) is time off.

In still yet another exemplary embodiment, the purge control method may further include monitoring a concentration of hydrogen discharged through a vehicle exhaust port. Here, when the concentration of discharged hydrogen is less than a predetermined reference concentration, the hydrogen purge valve may be controlled such that the hydrogen purge valve is opened according to the determined opening time and opening cycle.

In a further exemplary embodiment, when the concentration of discharged hydrogen is equal to or greater than the predetermined reference concentration, the opening of the hydrogen purge valve may be delayed, and in a next hydrogen purge in which the hydrogen purge valve is opened and then closed, a purge operation of the hydrogen purge valve may be further performed in addition to a purge operation to be performed at a current time.

In another further exemplary embodiment, in the next hydrogen purge in which the hydrogen purge valve is opened and then closed, the purge operation of the hydrogen purge valve may be further performed by a frequency proportional to a delay time.

In still another further exemplary embodiment, the opening of the hydrogen purge valve may be added once for a predetermined time per one minute of the delay time. Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a typical fuel cell system;

FIG. 2 is a graph illustrating a pressure difference maintained at a constant level between the anode and the cathode in a related art;

FIG. 3 is a view illustrating a configuration of a fuel cell system according to an exemplary embodiment of the present invention;

FIGS. 4 and 5 are flowcharts illustrating purge control methods for a fuel cell according to exemplary embodiments of the present invention;

FIG. 6 is a view illustrating an opening time (tₒₙ) and an opening cycle (t_{off}) of a hydrogen purge valve;

FIG. 7 is a graph illustrating a cell voltage deviation according to a differential pressure; and

FIG. 8 is a graph illustrating a durability pre/post stack voltage difference according to a differential pressure.

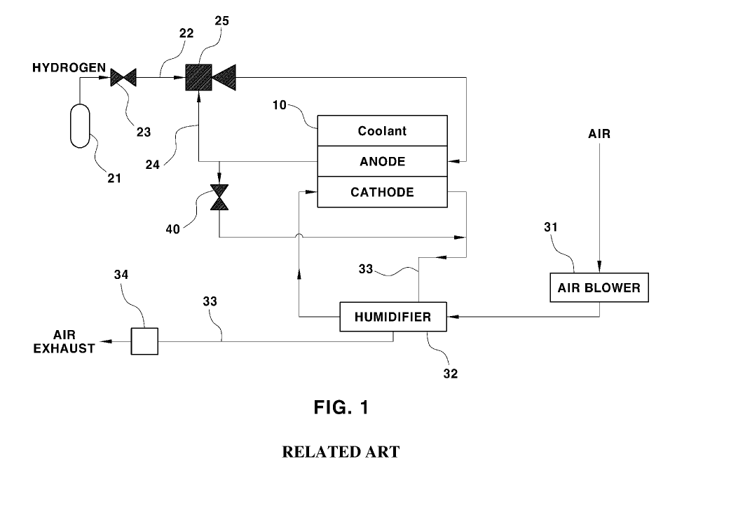

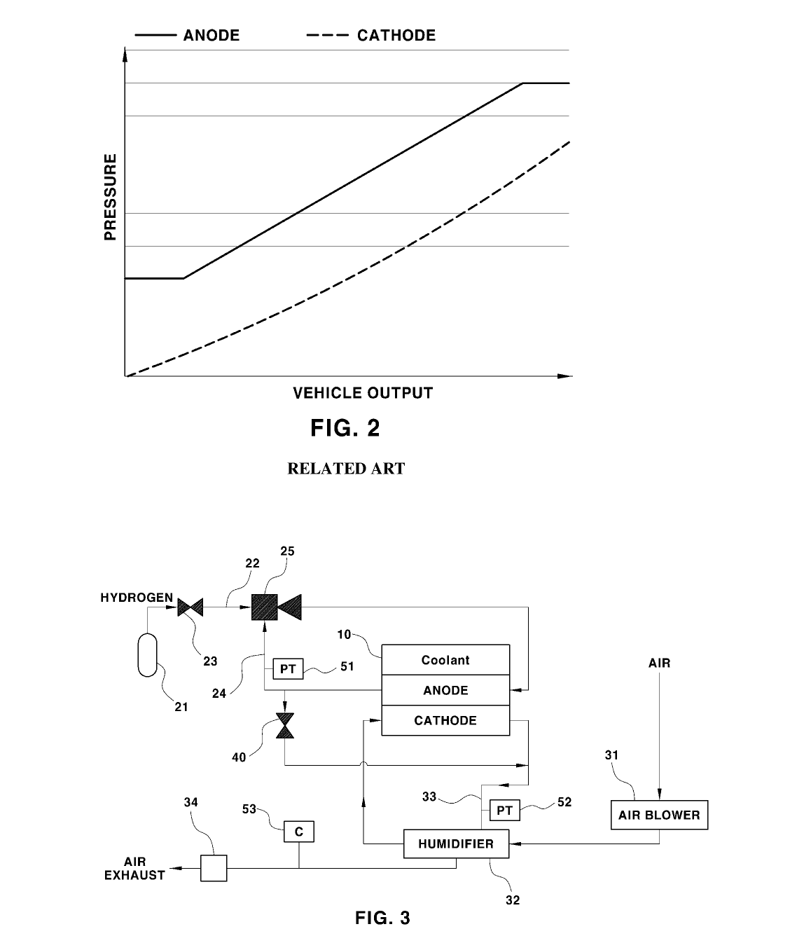

Reference numerals set forth in the Drawings includes reference to the following elements as further discussed below:

| | | | |
|---|---|---|---|
| 10: | fuel cell stack | 21: | hydrogen tank |
| 22: | hydrogen supply line | 23: | hydrogen supply valve |
| 24: | recirculation line | 25: | ejector |
| 31: | air blower | 32: | humidifier |
| 33: | air exhaust line | 34: | exhaust port |
| 40: | hydrogen purge valve | 51: | first pressure sensor |
| 52: | second pressure sensor | 52: | concentration sensor |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Hereinafter, exemplary embodiments of the present invention will be described in detail with reference to the accompanying drawings so that those skilled in the art can easily carry out the present invention.

FIG. 3 is a view illustrating a configuration of a fuel cell system according to an exemplary embodiment of the present invention. First and second pressure sensors 51 and 52 may be disposed to detect the pressures of the anode and the cathode of a fuel cell stack 10. Also, a concentration sensor 53 may be disposed to detect the hydrogen concentration (concentration of hydrogen discharged through a vehicle exhaust port, i.e., hydrogen concentration at the exhaust port) at an air exhaust line 33.

The first pressure sensor 51 for detecting the pressure of the anode may be disposed on a recirculation line (or hydrogen exhaust line) 24 of the rear end of the anode, i.e., the outlet side of the anode of the fuel cell stack 10. The second pressure sensor 52 for detecting the pressure of the cathode may be disposed on the air exhaust line 33 (air exhaust line connected to a humidifier at an upstream side thereof) of the rear end of the cathode, i.e., the outlet side of the cathode of the fuel cell stack 10.

Also, the concentration sensor 53 for detecting the concentration of hydrogen discharged through the exhaust port 34 may be disposed on the air exhaust line 33 at a downstream thereof, through which moisture-exchanged air in the humidifier 32 is discharged, connected from the humidifier 32 to the vehicle exhaust port 34.

Signals of the first pressure sensor 51, the second pressure sensor 52 and the concentration sensor 53, which are electrical signal according to the detection, may be inputted into a fuel cell system controller (not shown). The fuel cell system controller may control the opening/closing operations (purge operation) of a hydrogen purge valve 40 according to the signals of the first and second pressure sensors 51 and 52 and the concentration sensor 53.

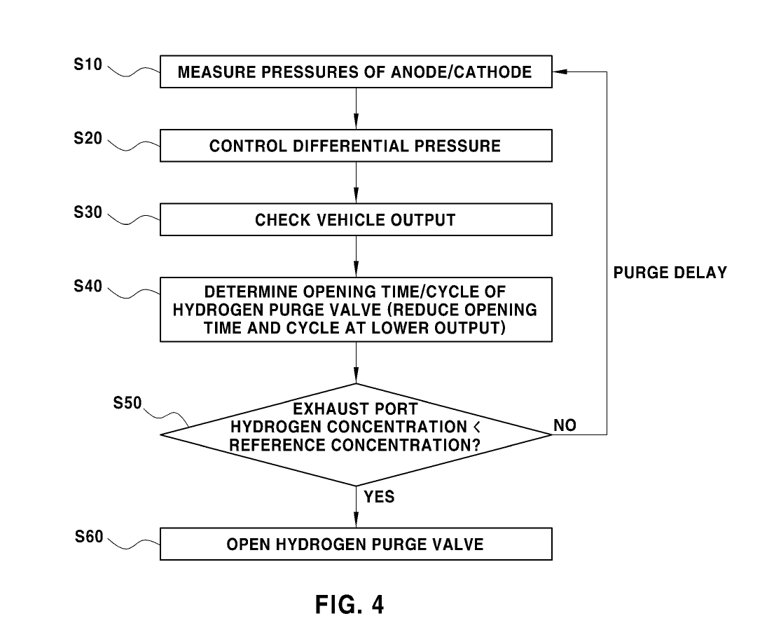

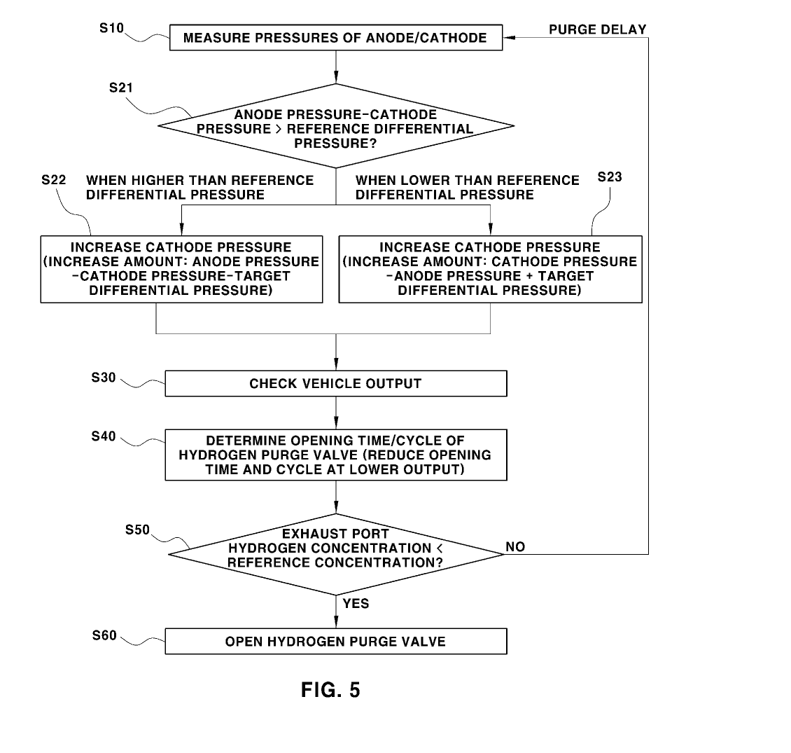

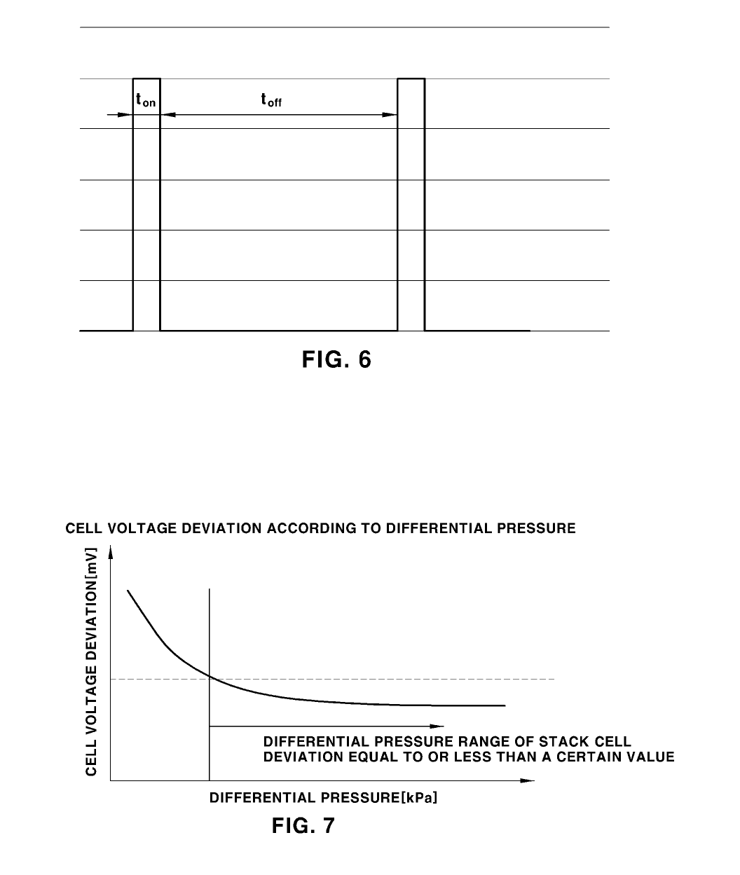

FIGS. 4 and 5 are flowcharts illustrating purge control methods for a fuel cell according to embodiments of the present invention. FIG. 6 is a view illustrating an opening time (tₒₙ) and an opening cycle (t_{off}) of a hydrogen purge valve.

FIG. 5 is a flowchart illustrating a more specific differential pressure control process compared to that of FIG. 4. Hereinafter, purge control methods for a fuel cell according to embodiments of the present invention will be described with reference to FIGS. 4 to 6.

The present invention relates to a fuel cell system of FIG. 3, which can control the concentration of hydrogen discharged by a purge through the control of a hydrogen purge valve 40.

When the hydrogen purge is performed by opening the hydrogen purge valve 40, hydrogen may be discharged due to the differential pressure, i.e., pressure difference between the anode and the cathode. The differential pressure may differ according to the types of vehicles.

First, the pressures of the anode and the cathode may be controlled such that a pressure difference (hereinafter, referred to as differential pressure) between the anode and the cathode can be maintained at a certain level using values of the respective pressure sensors 51 and 52 of the anode and the cathode before the hydrogen purge (S10 and S20). Thus, hydrogen can be discharged at the same flow rate when the hydrogen purge valve 40 is opened.

Here, when the certain differential pressure (predetermined reference differential pressure) is set too large, the purge time may become short. In this case, since foreign substances are not discharged as much as desired, the differential pressure needs to be appropriately set through a test.

Also, in operation S20, when the current differential pressure is larger than the predetermined reference differential pressure, the pressure of the cathode may be increased, and when the current differential pressure is smaller than the predetermined reference differential pressure, the pressure of the anode may be increased. Thus, the differential pressure between the anode and the cathode may be controlled according to the predetermined reference differential pressure such that the efficiency of the system is not reduced due to a pressure reduction.

In a fuel cell, when the pressures of the anode and the cathode are excessively lowered, the efficiency may be reduced due to the concentration gradient.

Referring to FIG. 5, when the current differential pressure is larger than the reference differential pressure, the pressure of the cathode may be increased to maintain the differential pressure at the reference differential pressure (S21 and S22). On the other hand, when the current differential pressure is less than the reference differential pressure, the pressure of the anode may be increased to maintain the differential pressure at the reference differential pressure (S23).

In this case, when the current differential pressure is greater than the reference differential pressure, the pressure of the cathode may be increased by a value of “anode pressure-cathode pressure-reference differential pressure”. When the current differential pressure is less than the reference differential pressure, the pressure of the anode may be increased by a value of “cathode pressure-anode pressure+reference differential pressure”.

Here, in order to increase the pressure of the anode, method technique of controlling a valve of a hydrogen supply line 22 or a regulator (not shown) of the hydrogen supply unit by allowing the fuel cell system controller to output control signals for the pressure control of the anode may be used.

Also, in order to increase the pressure of the cathode, a technique of controlling driving of the air blower 31 or a valve (not shown) of the air exhaust line 33 by allowing the fuel cell system controller to output control signals for the pressure control of the cathode may be used.

Also, the output (hereinafter, referred to as vehicle output) of the fuel cell stack 10 necessary for a vehicle may be checked (S30), and the opening time tₒₙ and the opening cycle t_{off} of the hydrogen purge valve 40 may be determined (S40). Thereafter, the hydrogen purge valve 40 may be opened according to the determined opening time tₒₙ and opening cycle t_{off} (S60).

Here, a map or a table in which the opening time tₒₙ (sec) and the opening cycle t_{off} (sec) of the hydrogen purge valve 40 are predefined according to the vehicle output A (or output of the fuel cell system) may be used. In this case, the fuel cell system controller may determine the opening time and the opening cycle of the hydrogen purge valve 40 using the map or the table according to a current vehicle output.

Alternatively, the fuel cell system controller may be configured to calculate the opening time tₒₙ and the opening cycle t_{off} of the hydrogen purge valve 40 using Equations (1) and (2) below.

tₒₙ (sec)=Vehicle Output(A)×Constant 1 (1)

t_{off} (sec)=Vehicle Output(A)×Constant 2 (2)

Here, constants 1 and 2 may be predetermined values (e.g., constant 1=0.002 and constant 2=20).

The definition of the opening time tₒₙ and the opening cycle t_{off} is shown in FIG. 6. Here, the opening cycle t_{off} may mean a time interval from a closing time point of the hydrogen purge valve 40 in a previous purge (discharge, i.e., opening/closing operations of the hydrogen purge valve) to an opening time point of the hydrogen purge valve 40 in a next purge.

In this case, since the amount of air is less at a lower output of a vehicle and the fuel cell system, the hydrogen concentration may be high at the exhaust port upon purge. Accordingly, the opening time and the opening cycle of the hydrogen purge valve 40 may be shortened. On the other hand, when the output of the fuel cell system is greater, the opening time and the opening cycle of the hydrogen purge valve 40 may be lengthened.

The fuel cell system controller may continuously monitor the concentration of discharged hydrogen through the concentration sensor 53 disposed at an inlet end of the exhaust port 34. When the concentration of discharged hydrogen is not lowered below a predetermined reference concentration (i.e., equal to or greater than the reference concentration), the opening of the hydrogen purge valve 40 may be delayed.

On the other hand, when the concentration of discharged hydrogen is less than the reference concentration, the fuel cell system controller may perform a hydrogen purge by opening the hydrogen purge valve 40 in compliance with the opening time and the opening cycle determined according to the vehicle output (S50 and S60).

Also, when the opening (hydrogen purge) of the hydrogen purge valve is delayed by the concentration of discharged hydrogen and since foreign substances increase in the anode while the hydrogen concentration is being lowered below the reference concentration, in the next hydrogen purge in which the hydrogen purge valve 40 is opened and then closed, the opening cycle may be shortened in comparison to the previous opening cycle. This increases the opening/closing operations (purge operation) of the hydrogen purge valve 40 by a certain frequency as a direct result. That is, the purge operation in which the hydrogen purge valve 40 is opened and then closed may be further performed by a certain frequency.

In this case, the frequency of the purge may be increased in proportion to the delay time, and more specifically, a technique of adding the opening of the hydrogen purge valve for a predetermined time by one time per one minute of delay time may be used.

For example, when the hydrogen purge is delayed for about three minutes, in the next purge (opening time point of the hydrogen purge valve), the frequency of the opening for about 0.1 second may be further added to this opening time by three times, thereby performing a total of four hydrogen purges (e.g., purge operations of the hydrogen purge valve).

In setting the reference differential pressure, since the exhaust amount varies according to the design of the fuel cell system and parts making up the fuel cell system upon opening of the hydrogen purge valve, the reference differential pressures (e.g., the reference pressure between the anode and the cathode) at the inlet and outlet ends of the hydrogen purge valve need to be differently set according to the types of the systems.

In the same system, the exhaust amount may be similar to each other when the differential pressure is equal, and the reference differential pressure needs to be set according to the system.

According to the variation of the differential pressure of the system, a voltage deviation between cells of the stack, durability, efficiency, and fuel efficiency may be changed. When the differential pressure is excessive, the increase of the exhaust amount, the reduction of the voltage deviation between stack cells, the increase of the durability, the reduction of the fuel efficiency, and the improvement of the efficiency may be shown. When the differential pressure is deficient, the reduction of the exhaust amount, the increase of the voltage deviation between stack cells, the reduction of the durability, the improvement of the fuel efficiency, and the reduction of the efficiency may be shown.

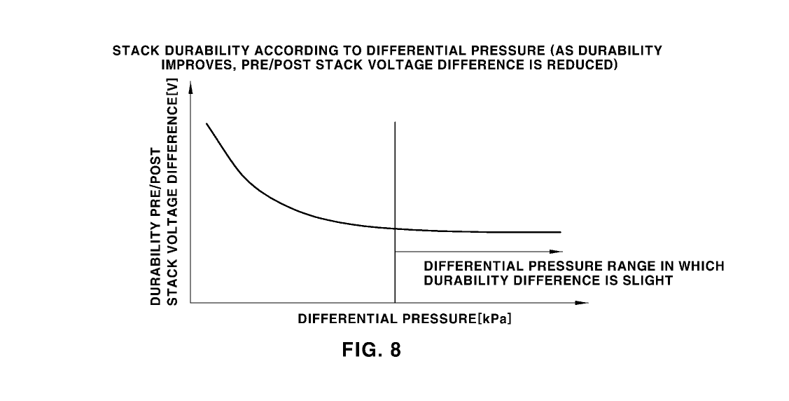

Accordingly, when the differential pressure is set through a test, as shown in FIG. 7, it is necessary to check the range of the differential pressure in which a voltage deviation between stack cells less than a certain value occurs, and then, as shown in FIG. 8, it is necessary to check a range of the durability reduction within the above-mentioned differential pressure range and then compare the fuel efficiency and the efficiency within the differential pressure range in which the durability is not reduced.

Thus, a purge control system and method for a fuel cell according to the exemplary embodiments of the present invention can increase the stability against fire and explosion by maintaining the concentration of discharged hydrogen at a desired level. Also, it is possible to accurately control the anode at a desired concentration by allowing hydrogen to be discharged at a constant rate through the hydrogen purge valve after maintaining a constant pressure difference through the control of the pressure difference (e.g., pressure controller of the anode and the cathode) when the hydrogen purge valve is opened. As such, deterioration of the fuel cell stack can be prevented by the management of foreign substances (e.g., nitrogen and water/vapor). Furthermore, since an excessive hydrogen purge is not performed, the utilization of hydrogen and the fuel efficiency can be improved.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A purge control method for a fuel cell, comprising:
measuring, by one or more sensors, pressures of an anode and a cathode;
controlling, by a controller based on measured pressures of the one or more sensors, the pressures of the anode and the cathode so that a pressure difference between the anode and the cathode is maintained at about a predetermined reference differential pressure;
determining, by the controller, an opening time and an opening cycle according to an output of a fuel cell stack necessary for a vehicle; and
controlling, by the controller, a hydrogen purge valve so that the hydrogen purge valve is opened according to the determined opening time and opening cycle.

2. The purge control method of claim 1, wherein when the pressure difference between the anode and the cathode is less than the reference differential pressure, the pressure of the anode is increased, and when the pressure difference between the anode and the cathode is greater than the reference differential pressure, the pressure of the cathode is increased.

3. The purge control method of claim 1, wherein when the pressure difference between the anode and the cathode is less than the reference differential pressure, the pressure of the anode is increased by a value of “cathode pressure−anode pressure+reference differential pressure”, and when the pressure difference between the anode and the cathode is greater than the reference differential pressure, the pressure of the cathode is increased by a value of “anode pressure−cathode pressure−reference differential pressure”.

4. The purge control method of claim 1, wherein as the output of the fuel cell stack becomes less, the opening time and the opening cycle of the hydrogen purge valve are shortened.

5. The purge control method of claim 1, wherein the opening time and the opening cycle of the hydrogen purge valve are determined by Equations (1) and (2) below:
tₒₙ (sec)=Vehicle Output(A)×Constant 1 (1)
t_{off} (sec)=Vehicle Output(A)×Constant 2 (2)
here, the constants 1 and 2 are predetermined values.

6. The purge control method of claim 1, further comprising monitoring a concentration of hydrogen discharged through an exhaust port,
wherein when the concentration of discharged hydrogen is less than a predetermined reference concentration, the hydrogen purge valve is opened according to the determined opening time and opening cycle.

7. The purge control method of claim 6, wherein when the concentration of discharged hydrogen is equal to or greater than the predetermined reference concentration, the opening of the hydrogen purge valve is delayed, and in a next hydrogen purge in which the hydrogen purge valve is opened and then closed, a purge operation of the hydrogen purge valve is further performed in addition to a purge operation to be performed at a current time.

8. The purge control method of claim 7, wherein in the next hydrogen purge in which the hydrogen purge valve is opened and then closed, the purge operation of the hydrogen purge valve is further performed by a frequency proportional to a delay time.

9. The purge control method of claim 8, wherein the opening of the hydrogen purge valve is added once for a predetermined time per one minute of the delay time.

10. A purge control system for a fuel cell, comprising:
a fuel cell stack;
a hydrogen purge valve configured to be opened in closed;
one or more sensors configured to measure pressures of an anode and a cathode of the fuel cell stack;
a controller programmed to control the pressures of the anode and the cathode so that a pressure difference between the anode and the cathode is maintained at about a predetermined reference differential pressure, determine an opening time and an opening cycle according to an output of the fuel cell stack necessary, and control the hydrogen purge valve to open according to the determined opening time and opening cycle.

11. The purge control system of claim 10, wherein when the pressure difference between the anode and the cathode is smaller than the reference differential pressure, the pressure of the anode is increased, and when the pressure difference between the anode and the cathode is larger than the reference differential pressure, the pressure of the cathode is increased.

12. The purge control system of claim 10, wherein when the pressure difference between the anode and the cathode is smaller than the reference differential pressure, the pressure of the anode is increased by a value of “cathode pressure−anode pressure+reference differential pressure”, and when the pressure difference between the anode and the cathode is larger than the reference differential pressure, the pressure of the cathode is increased by a value of “anode pressure−cathode pressure−reference differential pressure”.

13. The purge control system of claim 10, wherein as the output of the fuel cell stack necessary for the vehicle becomes smaller, the opening time and the opening cycle of the hydrogen purge valve are shortened.

14. The purge control system of claim 10, wherein the opening time and the opening cycle of the hydrogen purge valve are determined by Equations (1) and (2) below:
tₒₙ (sec)=Vehicle Output(A)×Constant 1 (1)
t_{off} (sec)=Vehicle Output(A)×Constant 2 (2)
here, the constants 1 and 2 are predetermined values.

15. The purge control system of claim 10, further comprising monitoring a concentration of hydrogen discharged through a vehicle exhaust port,
wherein when the concentration of discharged hydrogen is smaller than a predetermined reference concentration, the hydrogen purge valve is controlled such that the hydrogen purge valve is opened according to the determined opening time and opening cycle.

16. The purge control system of claim 15, wherein when the concentration of discharged hydrogen is equal to or larger than the predetermined reference concentration, the opening of the hydrogen purge valve is delayed, and in a next hydrogen purge in which the hydrogen purge valve is opened and then closed, a purge operation of the hydrogen purge valve is further performed in addition to a purge operation to be performed at a current time.

17. The purge control system of claim 16, wherein in the next hydrogen purge in which the hydrogen purge valve is opened and then closed, the purge operation of the hydrogen purge valve is further performed by a frequency proportional to a delay time.

18. The purge control system of claim 17, wherein the opening of the hydrogen purge valve is added once for a predetermined time per one minute of the delay time.

19. A non-transitory computer readable medium containing program instructions executed by a controller, the computer readable medium comprising:
program instructions that control pressures of an anode and an cathode of a fuel cell stack of a vehicle based on measured pressures from one or more sensors installed in the vehicle so that a pressure difference between the anode and the cathode is maintained at about a predetermined reference differential pressure;
program instructions that determine an opening time and an opening cycle according to an output of the fuel cell stack necessary; and
program instructions that control a hydrogen purge valve to open according to the determined opening time and opening cycle.
